(19) United States
(12) Patent Application Publication
(10) Pub. No.: US 2023/0385882 A1
(43) Pub. Date: Nov. 30, 2023

(54) SYSTEM AND METHOD FOR PROPERTY ANALYSIS

(71) Applicant: Cape Analytics, Inc., Palo Alto, CA (US)

(72) Inventors: Xiang Lee, Palo Alto, CA (US); Sarah Cebulski, Palo Alto, CA (US)

(21) Appl. No.: 18/303,990

(22) Filed: Apr. 20, 2023

Related U.S. Application Data
(60) Provisional application No. 63/333,118, filed on Apr. 20, 2022.
(60) Provisional application No. 63/333,492, filed on Apr. 21, 2022.

(51) Int. Cl. G06Q 30/02; G06Q 50/16

(52) U.S. Cl. CPC G06Q 30/0278; G06Q 50/163

(57) ABSTRACT

In variants, a method for property analysis can include: determining a property of interest, determining property information for the property, determining property attributes for the property, determining a value for the property, and optionally adjusting the value for the property. However, the method can additionally and/or alternatively include any other suitable elements.

### CROSS-REFERENCE TO RELATED APPLICATIONS

This application claims the benefit of U.S. Provisional Application Ser. No. 63/333,492 filed 21 Apr. 2022 and U.S. Provisional Application No. 63/333,118 filed 20 Apr. 2022, each of which is incorporated in its entirety by this reference.

### TECHNICAL FIELD

This invention relates generally to the real estate field, and more specifically to a new and useful method and system for property analysis in the real estate field.

### BRIEF DESCRIPTION OF THE FIGURES

FIG. 1 is a schematic representation of a variant of the method.

FIG. 2 is an illustrative example of a variant of the method.

FIG. 3 is an illustrative example of a variant of the method.

FIG. 4 is an illustrative example of predicting a property value using an automated valuation model (AVM).

FIG. 5 is an illustrative example of determining a market value for a property.

FIG. 6A is an illustrative example of segmenting a wide-scale image based on parcel boundaries.

FIG. 6B is an illustrative example of selecting a feature associated with the property from a set of features, detected by a feature detector.

FIG. 7 is an illustrative example of training an in-house AVM based on auxiliary property valuations.

FIG. 8 is a schematic representation of a variant of the method using one or more attributes determined using one or more features extracted from the property data.

FIGS. 9A, 9B, and 9C are schematic representations of examples of property attribute value determination.

FIG. 10 is an illustrative example of training an in-house AVM based on market trends (housing price index).

FIG. 11 is an illustrative example of training an in-house AVM based on auxiliary properties.

FIG. 12 is an illustrative example of adjusting a property value from a third-party AVM.

FIG. 13 is a schematic representation of a variant of the system.

### DETAILED DESCRIPTION

The following description of the embodiments of the invention is not intended to limit the invention to these embodiments, but rather to enable any person skilled in the art to make and use this invention.

### 1. Overview

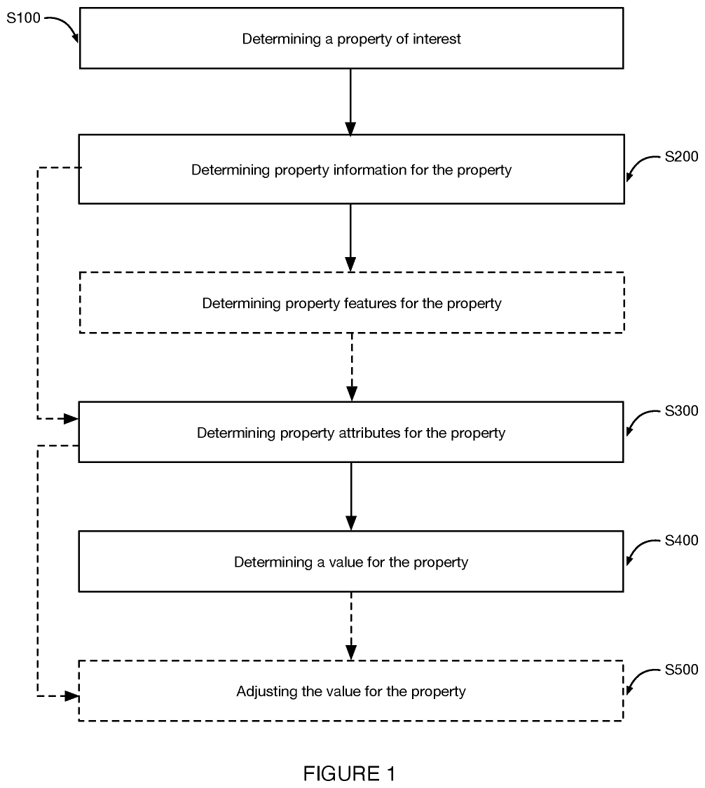

As shown in FIG. 1, the method for property analysis can include: determining a property of interest S100, determining a set of measurements for the property S200, determining property attributes for the property S300, determining a value for the property S400, and optionally adjusting the value for the property S500. However, the method can additionally and/or alternatively include any other suitable elements.

The method functions to predict a value that a property can be sold at, based on property attributes.

### 2. Examples

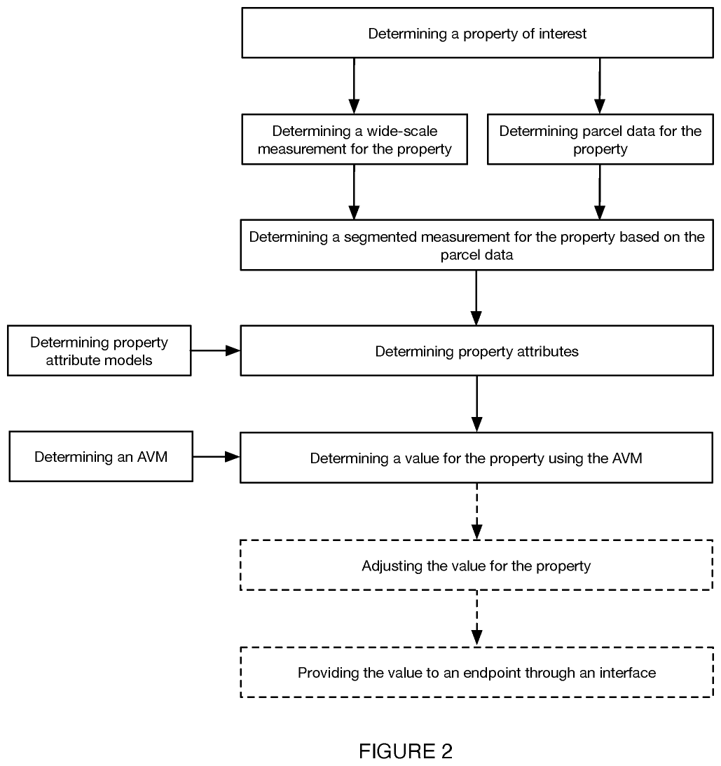

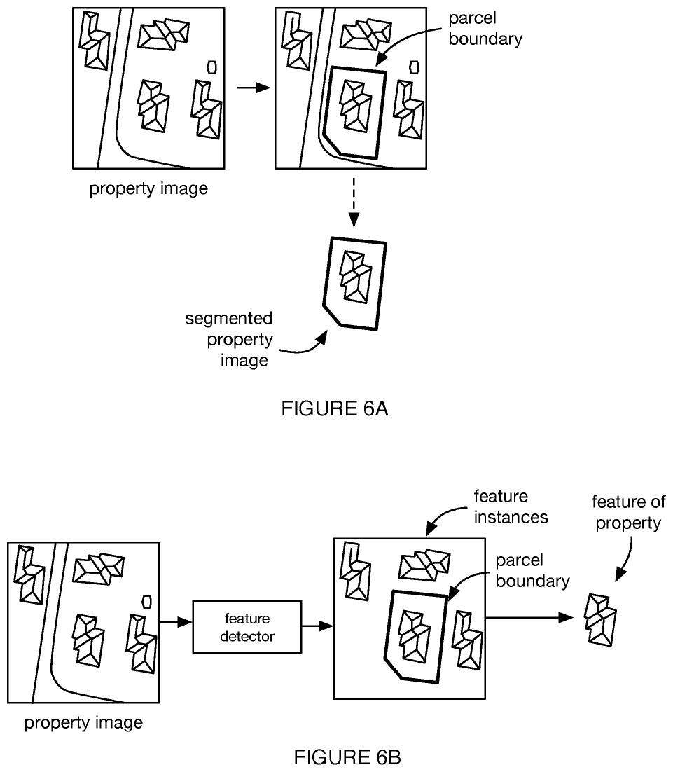

In an illustrative example, the method can include: identifying a property of interest, wherein the property can be associated with parcel data; retrieving property measurements, including a wide-scale image and optionally a digital surface model (DSM) depicting the property; optionally identifying the measurement segment (e.g., image segment, DSM segment, etc.) corresponding to the property based on the parcel data (examples shown in FIG. 2, FIG. 6A, and FIG. 6B); optionally extracting property features (e.g., roof, pool, vegetation, etc.) from the property measurements using a set of property feature detectors; using a property attribute model to determine property attribute values for the property based on the property measurements (e.g., wide-scale image, DSM, identified image segment, etc.) and/or property feature values; using an AVM (e.g., in-house AVM, third-party AVM, etc.) to predict a market value for the property based on the determined property attribute values and optionally other properties sharing similar attribute values with the property (e.g., market comparables for the property, auxiliary properties, etc.); optionally adjusting the market value for the property based on the determined property attribute values; and optionally providing the market value and/or adjusted market value to an endpoint. In examples, using a property attribute model to determine property attributes can include: inputting the image segment into a property attribute model to predict a property attribute value for one or more property attributes; inputting the image segment and a DSM into a property attribute model to predict a property attribute value for one or more property attributes; or inputting the wide-scale image, a DSM, and parcel data into a property attribute model to predict a property attribute value for one or more property attributes. The property attribute models can be trained by predicting a property attribute value for each of a set of properties given the respective property's image segments; comparing the predicted property value with an actual property attribute value for the property; and updating the property attribute models based on the comparison (e.g., using backpropagation, by updating the weights and/or connections, etc.), or otherwise trained. In examples, using an AVM to predict a market value for the property can include: inputting property attribute values into an AVM that outputs a predicted property valuation; or inputting property attribute values, auxiliary property valuations, and optionally auxiliary property attribute values into an AVM that outputs a predicted property valuation. Auxiliary properties (e.g., “comps”, “property comparables”, etc.) preferably share structural attribute values with the property of interest (e.g., similar bed/bath count, similar square footage, similar neighborhood, etc.), but can additionally and/or alternatively share market attribute values, and/or share any other suitable property attribute values. The AVM can be trained by predicting a valuation value for each of a set of properties, given the respective set of property attributes and/or the property image segment(s); comparing the predicted valuation value with an actual valuation value for the property (e.g., determined from an actual historical sale, determined by an appraiser, etc.); and updating the AVM based on the comparison (e.g., using backpropagation, by updating the weights and/or connections, etc.), or otherwise trained.

However, the method can be otherwise performed.

### 3. Technical Advantages

Variants of the technology for property analysis can confer several benefits over conventional systems and benefits.

First, current automated valuation models (AVMs) do not adequately account for nonstructural property attributes (e.g., property condition) and/or multi-factor property analytics when predicting a property valuation. This leads to inaccurate predictions. For example, properties with above-average condition have underestimated valuations, and properties with below-average condition have overestimated valuations. The inventors have discovered that AVMs can be enhanced (e.g., increased in accuracy) by leveraging machine learning to generate property attribute data, and using said property attribute data (e.g., condition attribute values) as inputs in an AVM. In variants, a set of computer vision models are used to predict property attributes for a property based on geospatial imagery, height map data, and/or parcel data of the property, wherein the AVM predicts a more-accurate valuation for the property based on the property attributes and/or auxiliary properties (e.g., other, recently-sold properties that share structural attribute values with the property of interest).

Second, variants of the technology can enhance the output of third-party AVMs using property attribute data. Since properties with below-average condition tend to have overestimated valuations, a downward adjustment (e.g., approximately up to 20%) to the final output provided by the third-party can increase valuation accuracy.

Third, variants of the technology can increase property analysis (e.g., condition-related attributes) accuracy by leveraging parcel data (e.g., parcel boundary, parcel shape, parcel position, etc.) for a property. In an example, the parcel data can be used to determine a segmented measurement for the property (e.g., isolated to the property) that is provided to the property attribute model. In another example, the parcel data can be used as additional information provided to the property attribute model (e.g., to focus the model on property-related pixels).

Fourth, variants of the technology can avoid expensive data collection techniques, such as in-person manual inspections and/or purchasing expensive datasets. Instead, property analysis (e.g., property attributes) are predicted using remote imagery (e.g., satellite imagery, aerial imagery, drone imagery, etc.).

Fifth, variants of the technology can return up-to-date results by using the most recent imagery for every request (e.g., collected within the last day, last week, last month, etc.). Variants of the technology can additionally return results for imagery taken for multiple different points in time and generate a timeseries of results to further evaluate property trends.

However, the technology can confer any other suitable benefits.

### 4. System

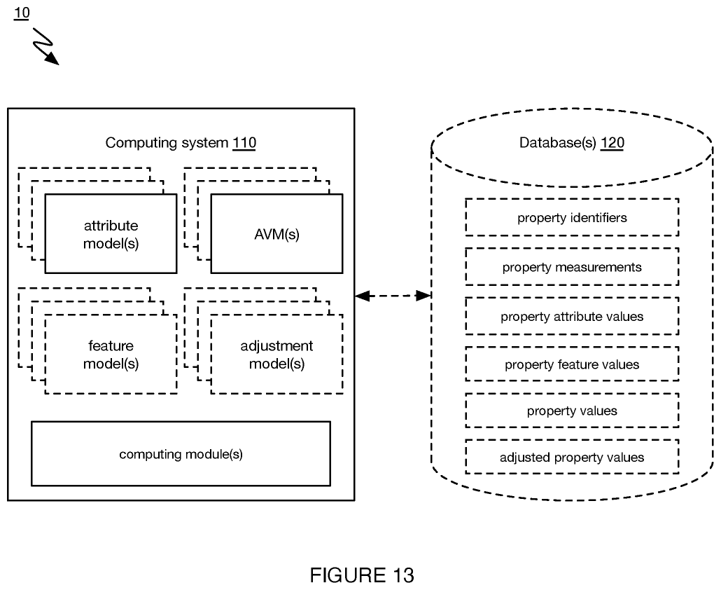

The method is preferably performed using a system 10 (example shown in FIG. 13), including: one or more computing systems 110, optionally one or more databases 120, and/or any other suitable components. However, the method can additionally and/or alternatively be performed using any other suitable system. The system 10 can function to facilitate execution of the method. However, the system 10 can provide any other suitable function.

### 4.1. Properties

The system 10 and/or method can be used with one or more properties. The properties can function as test properties (e.g., properties of interest), training properties (e.g., used to train the model(s)), and/or be otherwise used.

Each property can be or include: a land (e.g., a parcel, geographic region, etc.), a property component or set or segment thereof, and/or otherwise defined. For example, the property can include both the underlying land and improvements (e.g., built structures, fixtures, etc.) affixed to the land, only include the underlying land, or only include a subset of the improvements (e.g., only the primary building). Property components can include: built structures (e.g., primary structure, accessory structure, deck, pool, etc.); subcomponents of the built structures (e.g., roof, siding, framing, flooring, living space, bedrooms, bathrooms, garages, foundation, HVAC systems, solar panels, slides, diving board, etc.); permanent improvements (e.g., pavement, statutes, fences, etc.); temporary improvements or objects (e.g., trampoline); vegetation (e.g., tree, flammable vegetation, lawn, etc.); land subregions (e.g., driveway, sidewalk, lawn, backyard, front yard, wildland, etc.); debris; and/or any other suitable component. The property and/or components thereof are preferably physical, but can alternatively be virtual.

Each property can be identified by one or more property identifiers. A property identifier (property ID) can include: geographic coordinates, an address, a parcel identifier, a location identifier (e.g., Google Plus Codes™, Geohashes™, Place Key™, etc.), a block/lot identifier, a planning application identifier, a municipal identifier (e.g., determined based on the ZIP, ZIP+4, city, state, etc.), and/or any other identifier. The property identifier can be used to retrieve property information, such as parcel information (e.g., parcel boundary, parcel location, parcel area, etc.), property measurements, property descriptions, and/or other property data. The property identifier can additionally or alternatively be used to identify a property component, such as a primary building or secondary building, and/or be otherwise used.

### 4.2. Property Information

Each property can be associated with property information. The property information can be extracted from another piece of property information, retrieved from a third-party, received from a user, and/or be otherwise obtained. The property information can be static (e.g., remain constant over a threshold period of time) or variable (e.g., vary over time). The property information can be associated with: a time (e.g., a generation time, a valid duration, etc.), a source (e.g., the information source), an accuracy or error, and/or any other suitable metadata. The property information is preferably specific to the property, but can additionally or alternatively be from other properties (e.g., neighboring properties, other properties sharing one or more attributes with the property). Examples of property information can include: measurements, descriptions, attributes, auxiliary data, and/or any other suitable information about the property.

Property measurements preferably measure an aspect about the property, such as a visual appearance, geometry, and/or other aspect. In variants, the property measurements can depict a property (e.g., the property of interest), but can additionally or alternatively depict the surrounding geographic region, adjacent properties, and/or other factors. The measurement can be: 2D, 3D, and/or have any other set of dimensions. Examples of measurements can include: images, surface models (e.g., digital surface models (DSM), digital elevation models (DEM), digital terrain models (DTM), etc.), point clouds (e.g., generated from LIDAR, RADAR, stereoscopic imagery, etc.), depth maps, depth images, virtual models (e.g., geometric models, mesh models), audio, video, radar measurements, ultrasound measurements, and/or any other suitable measurement. Examples of images that can be used include: RGB images, hyperspectral images, multispectral images, black and white images, grayscale images, panchromatic images, IR images, NIR images, UV images, thermal images, and/or images sampled using any other set of wavelengths; images with depth values associated with one or more pixels (e.g., DSM, DEM, etc.); and/or any other suitable images.

The measurements can include: remote measurements (e.g., geospatial imagery, aerial imagery, satellite imagery, balloon imagery, drone imagery, etc.), local or on-site measurements (e.g., sampled by a user, streetside measurements, etc.), and/or sampled at any other proximity to the property. The remote measurements can be measurements sampled more than a threshold distance away from the property, such as more than 100 ft, 500 ft, 1,000 ft, any range therein, and/or sampled any other distance away from the property. The measurements can be: top-down measurements (e.g., nadir measurements, panoptic measurements, etc.), side measurements (e.g., elevation views, street measurements, etc.), angled and/or oblique measurements (e.g., at an angle to vertical, orthographic measurements, isometric views, etc.), and/or sampled from any other pose or angle relative to the property. The measurements can depict the property exterior, the property interior, and/or any other view of the property.

The measurements can be a full-frame measurement, a segment of the measurement (e.g., the segment depicting the property, such as that depicting the property's parcel; the segment depicting a geographic region a predetermined distance away from the property; etc.), a merged measurement (e.g., a mosaic of multiple measurements), orthorectified, and/or otherwise processed.

The measurements can be received as part of a user request, retrieved from a database, determined using other data (e.g., segmented from an image, generated from a set of images, etc.), synthetically determined, and/or otherwise determined.

The property information can include property descriptions. The property description can be: a written description (e.g., a text description), an audio description, and/or in any other suitable format. The property description is preferably verbal but can alternatively be nonverbal. The property description can be text-based, image-based, 3D-model based, and/or be otherwise represented. Examples of property descriptions can include: listing descriptions (e.g., from a realtor, listing agent, etc.), property disclosures, inspection reports, permit data, appraisal reports, and/or any other description of a property.

The property information can include auxiliary data. Examples of auxiliary data can include property descriptions, permit data, insurance loss data, inspection data, appraisal data, broker price opinion data, property valuations, property attribute and/or component data (e.g., values), and/or any other suitable data.

However, the property information can include any other suitable information about the property.

### 4.3. Property Attributes

Each property can be associated with a set of property attributes, which can function to represent one or more aspects of a given property. The property attributes can be semantic, quantitative, qualitative, and/or otherwise describe the property. Each property can be associated with its own set of property attributes, and/or share property attributes with other properties. As used herein, property attributes can refer to the attribute parameter (e.g., the variable) and/or the attribute value (e.g., value bound to the variable for the property).

Property attributes can include: property components, features (e.g., feature vector, mesh, mask, point cloud, pixels, voxels, any other parameter extracted from a measurement), any parameter associated with a property component (e.g., property component characteristics), semantic features (e.g., whether a semantic concept appears within the property information), and/or higher-level summary data extracted from property components and/or features. Property attributes can be determined based on property information for the property itself, neighboring properties, and/or any other set of properties. Property attributes can be automatically determined (e.g., by a model), manually determined (e.g., by an inspector), and/or otherwise determined.

Property attributes can be intrinsic, extrinsic, and/or otherwise related to the property. Intrinsic attributes are preferably inherent to the property's physical aspects, and would have the same values for the property independent of the property's context (e.g., property location, market conditions, etc.), but can be otherwise defined. Examples of intrinsic attributes include: record attributes, structural attributes, condition attributes, and/or other attributes determined from measurements or descriptions about the property itself. Extrinsic attributes can be determined based on other properties or factors (e.g., outside of the property). Examples of extrinsic attributes include: attributes associated with property location, attributes associated with neighboring properties (e.g., proximity to a given property component of a neighboring property), and/or other extrinsic attributes. Examples of attributes associated with the property location can include distance and/or orientation relative to a: highway, coastline, lake, railway track, river, wildland and/or any large fuel load, hazard potential (e.g., for wildfire, wind, fire, hail, flooding, etc.), other desirable site (e.g., park, beach, landmark, etc.), other undesirable site (e.g., cemetery, landfill, wind farm, etc.), zoning information (e.g., residential, commercial, and industrial zones; subzoning; etc.), and/or any other attribute associated with the property location.

Property attributes can include: structural attributes, condition attributes, record attributes, semantic attributes, subjective attributes, neighborhood attributes, market attributes, and/or any other suitable set of attributes.

Structural attributes can include: structure class/type, parcel area, framing parameters (e.g., material), flooring (e.g., floor type), historical construction information (e.g., year built, year updated/improved/expanded, etc.), area of living space, the presence or absence of a built structure (e.g., deck, pool, ADU, shed, garage, etc.), physical or geometric attributes of the built structure (e.g., structure footprint, roof surface area, number of roof facets, roof slope, roof pitch, pool surface area, square footage, living area, building material type, building height, number of beds, number of baths, number of stories, etc.), relationships between built structures (e.g., distance between built structures, built structure density, setback distance, count, etc.), presence or absence of an improvement (e.g., solar panel, etc.), ratios or comparisons therebetween, and/or any other structural descriptors.

Condition (e.g., condition-related) attributes can include: roof condition (e.g., tarp presence, material degradation, rust, missing or peeling material, sealing, natural and/or unnatural discoloration, defects, loose organic matter, ponding, patching, streaking, etc.), roof occlusion, wall condition, exterior condition, accessory structure condition, yard debris and/or lot debris (e.g., presence, coverage, ratio of coverage, etc.), lawn condition, pool condition, driveway condition, tree parameters (e.g., overhang information, height, etc.), vegetation parameters (e.g., coverage, density, setback, location within one or more zones relative to the property), presence of vent coverings (e.g., ember-proof vent coverings), structure condition, occlusion (e.g., pool occlusion, roof occlusion, etc.), pavement condition (e.g., percent of paved area that is deteriorated), resource usage (e.g., energy usage, gas usage, etc.), overall property condition, and/or other parameters (e.g., that are variable and/or controllable by a resident). Condition-related attributes can be a rating for a single structure, a minimum rating across multiple structures, a weighted rating across multiple structures, and/or any other individual or aggregate value.

Record attributes can include: number of beds/baths, construction year, square footage, legal class (e.g., residential, mixed-use, commercial, etc.), legal subclass (e.g., single-family vs. multi-family, apartment vs. condominium, etc.), location (e.g., neighborhood, zip code, etc.), location factors (e.g., positive location factors such as distance to a park, distance to school; negative location factors such as distance to sewage treatment plans, distance to industrial zones; etc.), population class (e.g., suburban, urban, rural, etc.), school district, orientation (e.g., side of street, cardinal direction, etc.) and/or any other suitable attributes (e.g., that can be extracted from a property record or listing).

Semantic attributes (e.g., semantic features) can include whether a semantic concept is associated with the property (e.g., whether the semantic concept appears within the property information). Examples of semantic attributes can include: whether a property is in good condition (e.g., “turn key”, “move-in ready”, or related terms appear in the description), “poor condition”, “walkable”, “popular”, small (e.g., “cozy” appears in the description), and/or any other suitable semantic concept. The semantic attributes can be extracted from: the property descriptions, the property measurements, and/or any other suitable property information. The semantic attributes can be extracted using a model (e.g., an NLP model, a CNN, a DNN, etc.) trained to identify keywords, trained to classify or detect whether a semantic concept appears within the property information, and/or otherwise trained.

Subjective attributes can include: curb appeal, viewshed and/or viewshed desirability, and/or any other suitable attributes.

Neighborhood attributes can include: typicality (e.g., of property relative to neighbors), structural density, and/or any other suitable attributes.

Market attributes can include: liquidity (e.g., how easily a property can be sold without reducing price), geographic region, market state (e.g., bull market, bear market, etc.), market interest rates, transaction type (e.g., standard sale, bank-owned or real-estate-owned sale, short sale, etc.), house price index (HPI), and/or any other suitable attributes.

Other property attributes can include: built structure values (e.g., roof slope, roof rating, roof material, root footprint, covering material, etc.), auxiliary structures (e.g., a pool, a statue, ADU, etc.), risk asset scores (e.g., asset score indicating risk of flooding, hail, wildfire, wind, house fire, etc.), neighboring property values (e.g., distance of neighbor, structure density, structure count, etc.), and/or any other suitable attributes.

Example property attributes can include: structural attributes (e.g., for a primary structure, accessory structure, neighboring structure, etc.), record attributes (e.g., number of bed/bath, construction year, square footage, legal class, legal subclass, geographic location, etc.), condition attributes (e.g., yard condition, roof condition, pool condition, paved surface condition, etc.), semantic attributes (e.g., semantic descriptors), location (e.g., parcel centroid, structure centroid, roof centroid, etc.), property type (e.g., single family, lease, vacant land, multifamily, duplex, etc.), property component parameters (e.g., area, enclosure, presence, structure type, count, material, construction type, area condition, spacing, relative and/or global location, distance to another component or other reference point, density, geometric parameters, condition, complexity, etc.; for pools, porches, decks, patios, fencing, etc.), storage (e.g., presence of a garage, carport, etc.), permanent or semi-permanent improvements (e.g., solar panel presence, count, type, arrangement, and/or other solar panel parameters; HVAC presence, count, footprint, type, location, and/or other parameters; etc.), temporary improvement parameters (e.g., presence, area, location, etc. of trampolines, playsets, etc.), pavement parameters (e.g., paved area, percent illuminated, paved surface condition, etc.), foundation elevation, terrain parameters (e.g., parcel slope, surrounding terrain information, etc.), legal class (e.g., residential, mixed-use, commercial), legal subclass (e.g., single-family vs. multi-family, apartment vs. condominium), geographic location (e.g., neighborhood, zip, etc.), population class (e.g., suburban, urban, rural, etc.), school district, orientation (e.g., side of street, cardinal direction, etc.), subjective attributes (e.g., curb appeal, viewshed, etc.), built structure values (e.g., roof slope, roof rating, roof material, roof footprint, covering material, number of roof facets, etc.), auxiliary structures (e.g., a pool, a statue, ADU, etc.), risk scores (e.g., score indicating risk of flooding, hail, fire, wind, wildfire, etc.), neighboring property values (e.g., distance to neighbor, structure density, structure count, etc.), context (e.g., hazard context, geographic context, vegetation context, weather context, terrain context, etc.), historical construction information, historical transaction information (e.g., list price, sale price, spread, transaction frequency, transaction trends, etc.), semantic information, and/or any other attribute that remains substantially static after built structure construction.

In variants, the set of attributes that are used (e.g., by the model(s)) can be selected from a superset of candidate attributes. This can function to: reduce computational time and/or load (e.g., by reducing the number of attributes that need to be extracted and/or processed), increase score prediction accuracy (e.g., by reducing or eliminating confounding attributes), and/or be otherwise used. The set of attributes can be selected: manually, automatically, randomly, recursively, using an attribute selection model, using lift analysis (e.g., based on an attribute's lift), using any explainability and/or interpretability method, based on an attribute's correlation with a given metric or training label, using predictor variable analysis, through predicted outcome validation, during model training (e.g., attributes with weights above a threshold value are selected), using a deep learning model, based on a zone classification, and/or via any other selection method or combination of methods.

Attribute values can be discrete, continuous, binary, multiclass, and/or otherwise structured. The attribute values can be associated with time data (e.g., from the underlying measurement timestamp, value determination timestamp, etc.), a hazard event, an uncertainty parameter, and/or any other suitable metadata.

Attribute values can optionally be associated with an uncertainty parameter. Uncertainty parameters can include variance values, a confidence score, and/or any other uncertainty metric. In a first illustrative example, the attribute value model classifies the roof material for a structure as: shingle with 90% confidence, tile with 7% confidence, metal with 2% confidence, and other with 1% confidence. In a second illustrative example, 10% of the roof is obscured (e.g., by a tree), which can result in a 90% confidence interval for the roof geometry attribute value. In a third illustrative example, the vegetation coverage attribute value is 70%±10%. In a fourth illustrative example, attributes can be characterized with a quantile distribution of attribute values (e.g., wherein the uncertainty parameter for each attribute value is determined based on the quantile that the value falls within or a probability of the quantile distribution).

The attributes can be determined from property information (e.g., property measurements, property descriptions, etc.), a database 120 or a third party source (e.g., third-party database, MLS™ database, city permitting database, historical weather and/or hazard database, tax assessor database, etc.), be predetermined, be calculated (e.g., from an extracted value and a scaling factor, etc.), and/or be otherwise determined. In a first example, the attributes can be determined by extracting features from property measurements, wherein the attribute values can be determined based on the extracted feature values. In a second example, a trained attribute model can predict the attribute value directly from property information (e.g., based on property imagery, descriptions, etc.). In a third example, the attributes can be determined by extracting features from a property description (e.g., using a sentiment extractor, keyword extractor, etc.). However, the attributes can be otherwise determined. In examples, property attributes and/or values thereof can defined and/or determined as disclosed in U.S. application Ser. No. 18/092,689 filed 3 Jan. 2023, U.S. application Ser. No. 17/526,769 filed 15 Nov. 2021, U.S. application Ser. No. 17/546,620 filed 9 Dec. 2021, U.S. application Ser. No. 17/529,836 filed 18 Nov. 2021, U.S. application Ser. No. 17/749,385 filed 20 May 2022, U.S. application Ser. No. 18/121,114 filed 14 Mar. 2023, U.S. application Ser. No. 17/858,422 filed 6 Jul. 2022, U.S. application Ser. No. 17/968,662 filed 18 Oct. 2022, U.S. application Ser. No. 17/841,981 filed 16 Jun. 2022, U.S. application Ser. No. 18/074,295 filed 2 Dec. 2022, and/or U.S. application Ser. No. 18/098,841 filed 19 Jan. 2023, U.S. application Ser. No. 18/100,736 filed 24 Jan. 2023, each of which is incorporated in its entirety by this reference (e.g., wherein features and/or feature values disclosed in the references can correspond to attributes and/or attribute values).

Property attributes and/or attribute values are preferably determined contemporaneously with method execution, asynchronously from method execution, in real time or near real time (NRT) with respect to the method, and/or with any other suitable frequency and/or timing. Attributes and values can be stored by the processing system performing the determination of property attributes, and/or by any other suitable system. Preferably, storage can be temporary, based on time (e.g., 1 day, 1 month, etc.), based on use (e.g., after one use of the property attribute values by the asset prediction model), based on time and use (e.g., after one week without use of property attribute values), and/or based on any other considerations. Alternatively, property asset data is permanently stored.

However, any other suitable property attribute and/or value thereof can be determined.

### 4.4. Models

The system can be used with one or more models. The models can be or include: neural networks (e.g., CNN, DNN, CV model, etc.), an equation (e.g., weighted equations), regression (e.g., leverage regression), a curve, foundation models (e.g., GPT-3, BERT, DALL-E 2, etc.), classification (e.g., binary classifiers, multiclass classifiers, semantic segmentation models, instance-based segmentation models, etc.), segmentation algorithms (e.g., neural networks, such as CNN based algorithms, thresholding algorithms, clustering algorithms, etc.), rules, heuristics (e.g., inferring the number of stories of a property based on the height of a property), instance-based methods (e.g., nearest neighbor), regularization methods (e.g., ridge regression), decision trees, Bayesian methods (e.g., Naïve Bayes, Markov, etc.), kernel methods, statistical methods (e.g., probability), deterministics, support vectors, genetic programs, isolation forests, robust random cut forest, clustering, selection and/or retrieval (e.g., from a database and/or library), comparison models (e.g., vector comparison, image comparison, etc.), object detectors (e.g., CNN based algorithms, such as Region-CNN, fast RCNN, faster R-CNN, YOLO, SSD-Single Shot MultiBox Detector, R-FCN, etc.; feed forward networks, transformer networks, generative algorithms (e.g., diffusion models, GANs, etc.), and/or other neural network algorithms), key point extraction, SIFT, any computer vision and/or machine learning method (e.g., CV/ML extraction methods), and/or any other suitable model or methodology. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights can be learned through training); a set of connected convolution layers (e.g., in a CNN); a set of self-attention layers; and/or have any other suitable architecture.

The models can be trained (e.g. pre-trained) using: self-supervised learning, semi-supervised learning, supervised learning, unsupervised learning, reinforcement learning, transfer learning, Bayesian optimization, positive-unlabeled learning, using backpropagation methods (e.g., by propagating a loss calculated based on a comparison between the predicted and actual training target back to the model; by updating the architecture and/or weights of the model based on the loss; etc.), and/or otherwise learned. The model can be learned or trained on: labeled data (e.g., data labeled with the target label), unlabeled data, positive training sets (e.g., a set of data with true positive labels), negative training sets (e.g., a set of data with true negative labels), and/or any other suitable set of data.

The system 10 and/or method can include and/or be used with: one or more property attribute models, one or more automated valuation models, one or more adjustment models, and/or any other suitable models.

The one or more (property) attribute models can function to determine values for one or more property attributes. The system 10 can include one or more property attribute models for: one or more property attributes, one or more locations, one or more property classes, one or more time intervals, one or more providers, one or more third-parties, one or more modalities, combinations thereof, and/or any other suitable parameters. Each property attribute model can determine values for one or more property attributes, or not determine values for one or more property attributes. Each attribute model can determine values for a single attribute (e.g., be a binary classifier, be a multiclass classifier, etc.), multiple attributes (e.g., be a multiclass classifier), and/or for any other suitable set of attributes. A single attribute value can be determined using a single attribute model, multiple attribute models, and/or any other suitable number of attribute models. Each property attribute model can be specific to contextual parameter values, a property, a property class (e.g., house, physical structure, etc.), a property subclass (e.g., single-family house, multi-family house, etc.) a location (e.g., by street, by town, by city, by state, by country, by zip code, etc.), a location type (e.g., suburban, rural, urban, etc.), a perspective (e.g., exterior, interior, front view, back view, etc.), a metadata value (e.g., modality, provider, etc.), and/or be otherwise specific. Additionally and/or alternatively, the model can be generic across contextual parameter values, properties, property classes, property subclasses, locations, location types, perspectives, and/or be otherwise generic.

Inputs of each property attribute model, used to determine attribute values for a property of interest, can include: property information (examples described above) for the property of interest, property information for associated properties (e.g., neighboring properties to the property of interest, auxiliary properties, etc.), and/or any other suitable set of inputs. The property information can include: measurements (e.g., RGB images, 2D images, 3D images, geometric information, DSM, etc.), descriptions, parcel data, auxiliary data, a property identifier, a geographic identifier, and/or any other suitable information for a property. The property information can be associated with: a single property, a larger geographic context (e.g., based on a region larger than the property parcel size), and/or be otherwise associated with one or more properties. The inputs can optionally be associated: with a common timestamp, with a common timeframe (e.g., all determined within the same week, month, quarter, season, year, etc.), with different timestamps, with different timeframes, and/or be otherwise temporally related. Each property attribute model can predict, extract, and/or otherwise determine property attribute values for a property.

Outputs of each property attribute model can include: values for one or more property attributes, measurements for a property, image feature segments, property identifiers, uncertainty parameters (e.g., a confidence score for each attribute value prediction), and/or any other suitable outputs.

In a first variant, the property attribute model can be a neural network (NN) that extracts the property attribute value from property measurements. The NN can be trained using training property measurements (and/or features extracted therefrom) associated with ground-truth attribute values (e.g., determined by a user, calculated from a ranking, etc.).

In a second variant, the property attribute model can be a model that post-processes features extracted from property measurements. In a first example, the living area footprint can be calculated from the roof footprint. In a second example, the distance between the centroid of two detected built structures can be determined. In a third example, a parcel shape (e.g., rectangular, square, pie-shaped, triangular-shaped, reverse pie-shaped, irregularly-shaped, etc.) and/or parcel position (e.g., at the end of a dead-end street that serves as a cul-de-sac; between the intersection of two streets such as a corner position; bordered by three or more parcels on all sides of the parcel except the frontage such as a key position; surrounded by parcels on the side yards such as an interior position; located in front of an intersection between two streets such as a T-intersection position; when the frontage can only be accessed through narrow access driveways such as a flag position; etc.) can be determined from the parcel information and/or the image. In a fourth example, a liquidity metric can be determined based on attributes extracted from the image and/or the parcel data (e.g., calculated based on the parcel shape and/or parcel position). In this variant, the system 10 can additionally and/or alternatively include a property feature model (e.g., feature detector, feature extractor, etc.) that extracts the property feature (e.g., roof, pool, vegetation, etc.) from the property measurements. The property feature model can be trained using training measurements annotated with feature instances. For example, the property attribute model is a debris score model as discussed in U.S. application Ser. No. 17/502,825 filed 15 Oct. 2021, which is incorporated in its entirety by this reference. However, features can be otherwise used to determine the property attribute value.

However, the one or more property attribute models can be otherwise configured.

The one or more automated valuation models (AVMs) can function to predict a valuation for a property. The system 10 can include one or more AVMs for: different property attributes (e.g., property attribute sets and/or property attribute value sets), different locations (e.g., a zip code, a neighborhood, etc.), different property classes (e.g., single-family home, multi-family home, etc.), different property subclasses (e.g., industrial zoning, multi-use zoning, office zoning, etc.), different time intervals, different providers, different third-parties (e.g., third-party AVM systems), combinations thereof, and/or any other suitable parameter. Each AVM can determine property values for one property, multiple properties, and/or any other suitable number of properties. A single property value can be determined using a single AVM, multiple AVMs, and/or any other suitable number of AVMs.

Inputs of the AVM can include: attribute values for a property of interest (e.g., condition attribute values, market attribute values, etc.), property values for auxiliary properties, attribute values for auxiliary properties, historical sale prices for the property, historical sale prices for auxiliary properties, property information for a property of interest, property information for auxiliary properties, and/or any other suitable set of inputs. In a first example, inputs of the AVM are only property condition attribute values of a property. In a second example, inputs of the AVM are property attribute values of a property and a valuation for auxiliary properties. In a third example, inputs of the AVM are all property attribute values of a property. In a fourth example, inputs of the AVM include the property attribute values for the property of interest, the property attribute values for the auxiliary properties, and the auxiliary property valuations. However, inputs of the AVM can include any other suitable inputs.

Outputs of the AVM can include: a value for a property, an uncertainty parameter associated with the estimated property value (e.g., the error of the estimated property value), a ranking of values between a property and its auxiliary properties, and/or any other suitable outputs.

However, the one or more AVMs can be otherwise configured.

The one or more adjustment models (e.g., error model) can function to adjust the predicted valuation of an automated valuation model. The adjustment model preferably adjusts the valuation post-prediction, but can alternatively adjust AVM input values, and/or adjust any other suitable value. The system 10 can include one or more adjustment models for: different AVMs, different third-parties (e.g., third-party AVM systems), different property attributes (e.g., property attribute sets and/or property attribute value sets), different locations (e.g., a zip code, a neighborhood, etc.), different property classes (e.g., single-family home, multi-family home, etc.), different property subclasses (e.g., industrial zoning, multi-use zoning, office zoning, etc.), different time intervals, different providers, combinations thereof, and/or any other suitable parameter.

Inputs of the adjustment model can include: property values for a property of interest (e.g., predicted by an AVM, most recent sale price, prior sale price, etc.), attribute values for a property of interest (e.g., condition attribute values, market attribute values, etc.), property values for auxiliary properties, attribute values for auxiliary properties, historical sale prices for the property, historical sale prices for auxiliary properties, property information for a property of interest, property information for auxiliary properties, the P10 or PPE10 for the predicted value (e.g., percentage of times an AVM is within 10 percent of the benchmark), the spread of the AVM, and/or any other suitable set of inputs. In an illustrative example, the adjustment values can be determined (e.g., calculated, looked up, etc.) based on one or more attribute values for the property However, inputs of the adjustment model can include any other suitable inputs.

Outputs of the adjustment model can include: an adjustment factor (e.g., a multiplier, a percentage, a property value discount, etc.), an adjusted property value for a property of interest (e.g., compared to the predicted property value outputted by the AVM), a difference value between an AVM predicted property value and an adjusted property value, an AVM predicted property value, an uncertainty parameter (e.g., associated with the adjusted property value, associated with the property value discount, etc.), and/or any other suitable outputs.

The adjustment model can be: a curve, a lookup table, a trained machine learning model, and/or any other suitable model. The adjustment model can be specific to the AVM, specific to a timeframe or market condition, specific to a geographic region (e.g., a zip code, a market class, etc.), generic, and/or be otherwise specific or shared. The valuation adjustment (e.g., for each attribute value) can be determined based on a comparison between the predicted and actual: valuations, home price indices, rank, and/or other market position measure (e.g., error, PPE10, etc.) for each of a set of properties (e.g., test properties, auxiliary properties, etc.)

However, the one or more adjustment models can be otherwise configured.

However, the system 10 can include and/or be used with any other suitable models.

The system 10 can include one or more computing systems 110, which can function to execute all or portions of the method, execute one or more modules of the system 10, and/or perform any other suitable functionality. The computing system no is preferably a remote computing system (e.g., a platform, a server system, etc.), but can additionally and/or alternatively be performed by a distributed computing system, a local computing system (e.g., a user device such as a smartphone, a laptop, a desktop, a tablet, etc.), a centralized computing system, a combination thereof, and/or any be otherwise configured. The computing system 110 can be used with a user interface or not be used with a user interface. The user interface can be used to: receive and/or input property identifiers and/or property requests, present attribute values, present feature values, present property values (e.g., unadjusted property values, unadjusted property values, etc.), and/or be otherwise used. The user interface can be: a graphic user interface, a command line interface, an application programming interface (API), and/or any other suitable type of interface. The interface can be an application (e.g., browser application, native application, etc.) on a user device (e.g., laptop, desktop, mobile phone, tablet, etc.), an API, and/or any other suitable interface. The computing system 110 can optionally interface with the one or more databases 120.

In variants, the one or more computing systems 10 can include one or more computing modules, which can function to facilitate execution of method elements. The one or more computing modules can be executed contemporaneously, synchronously, asynchronously, in series, in parallel, and/or be otherwise implemented. In a first example, the computing system 110 can include a first computing module which functions to determine one or more attributes values in accordance with S300 and a second computing module which functions to determine a property value associated with the property in accordance with S400. In a second example, the computing system 110 can include a single computing module which can function to facilitate execution of an instance of the method. However, the one or more computing modules can be otherwise configured.

However, the one or more computing systems 110 can be otherwise configured.

The system 10 can include one or more databases 120, which can function to store property data such as: property identifiers, property information (e.g., measurements, auxiliary data, etc.), attribute values, feature values, property values (e.g., unadjusted property values, adjusted property values, etc.). and/or any other suitable information. The database 120 can be a remote database, a local database, a distributed database, a centralized database, a cloud database, a combination thereof, and/or any be otherwise configured. The database 120 can be a NoSQL database, a relational database (RDS), a hierarchical database, and/or any other suitable database. The database 120 is preferably queryable (e.g., based on a property identifier) to retrieve property data, but can additionally and/or alternatively not be queryable. The database 120 can be and/or interface with a third-party source (e.g., a third-party database, a real estate listing database, tax assessor database, city permitting database, etc.), but can alternatively not interface with a third-party source. The information in the database 120 can be retrieved from, linked to, and/or be otherwise associated with a third-party source. For example, a property identifier for each of a set of properties is stored in the database 120, wherein attribute values are stored in association with the corresponding property identifier for all or a subset of the properties. Attribute values can optionally be edited and/or appended to the database when new property information (e.g., recent imagery or other measurements) is added.

However, the one or more databases 120 can be otherwise configured.

However, the system 10 can include any other suitable components.

### 5. Method

The method can include: determining a property of interest S100, determining property information for the property S200, determining property attributes for the property S300, determining a value for the property S400, and optionally adjusting the value for the property S500. However, the method can be otherwise performed.

One or more instances of the method can be performed for one or more properties of interest, one or more time frames, one or more attribute sets and/or attribute value sets, one or more providers, one or more third-parties, one or more property attribute models, one or more property feature models, one or more automated valuation models, and/or otherwise performed.

All or portions of the method is preferably performed by the system 10 disclosed above (e.g., a platform), but can additionally and/or alternatively be performed by a local system, a third-party system, and/or any other suitable system. In an example, the system 10 uses an in-house AVM to predict a property value for a property of interest. In another example, a third-party system uses a third-party AVM to predict a property value for the property of interest and the system 10 optionally adjusts the predicted property value.

All or portions of the method can be performed: once, periodically, repeatedly, in response to a request from an endpoint, before receipt of a request, upon occurrence of a predetermined event, upon receipt of a new measurement, upon determination of a new attribute value, and/or any other suitable time and/or frequency. In an example, the method can be executed in response to a user request (e.g., via an API) for a property of interest. In another example, various portions of the method can be precomputed for a property of interest (e.g., attribute values can be precomputed and/or stored in a database 120) prior to a user request for information related to the property of interest.

The method can be performed for a property identified in the request (e.g., for an insurance entity, for a property investor, etc.), for a manually identified property, for a randomly determined property, for all properties within a geographic region (e.g., manually-determined geographic region, all properties depicted in an image, etc.), and/or for any other suitable property.

However, the method can be used with any other set of data.

### 5.1. Determining a Property of Interest S100.

Determining a property of interest S100 functions to determine a property to be evaluated. S100 can be performed before S200, concurrently with S200, after S200, concurrently with S300, and/or at any other suitable time. The property of interest can be a real property (e.g., land and built structure), a built structure, a segment of a built structure, and/or any other suitable subject (described above). The property can be identified by: a property identifier (e.g., an address, a lot number, latitude/longitude coordinates, a parcel number, a block number, etc.), not be associated with an identifier, and/or otherwise identified. The property of interest is preferably received from a user (e.g., on an interface), but can additionally and/or alternatively be received in a request from an endpoint, and/or otherwise determined. The property of interest can be received as a standalone property, received as part of a set of properties, and/or otherwise received. The set of properties can be determined from: a list of properties, properties within a geographic region, properties currently on the market, and/or otherwise determined. However, the property of interest can be otherwise determined.

### 5.2. Determining Property Information for the Property S200.

Determining property information for the property S200 functions to determine a measurement depicting a property of interest. S200 can be performed after 100, asynchronously with S100, concurrently with S100, and/or at any other suitable time.

S200 can include determining a set of measurements for the property. The set of measurements can include one measurement, multiple measurements, and/or any other suitable number of measurements. In an example, the set of measurements can include a 2D image (e.g., RGB image) and a geometric measurement (e.g., DSM). In another example, the set of measurements can include only a 2D image. However, any other set of measurements can be used. Each measurement is preferably an image, but can additionally and/or alternatively be a video, audio, depth information (e.g., digital surface model, digital elevation model, etc.), geometric measurements (e.g., 3D point clouds, RADAR, LIDAR, etc.), a virtual model, and/or any other suitable measurement. The image is preferably a remote image (e.g., an image taken of a remote scene, satellite image, aerial image, drone image, etc.), but can additionally and/or alternatively be a local image, and/or any other suitable image. The image can be a top-down image, an oblique image, and/or taken from any other angle. Each measurement can depict: only the property of interest (e.g., a property-specific measurement, wherein a wide-scale measurement depicting the property can be cropped using the parcel data); depict multiple properties that includes the property of interest; not depict the property of interest; and/or depict any other suitable property. Each measurement is preferably the most recent measurement of the property of interest (e.g., based on a timestamp of when the measurement was captured), but can additionally and/or alternatively be an older measurement of the property of interest (e.g., a measurement that was contemporaneously sampled with a historical valuation for the property), and/or a measurement captured at any other suitable time. Each measurement can be associated with contextual parameter values (e.g., associated with the measurement context), or not be associated with contextual parameter values. Contextual parameter values can include: a scene class (e.g., interior scene measurement, exterior scene measurement, etc.), a perspective (e.g., front elevation, rear elevation, side elevation, top planar view, isometric view, etc.), a provider, a modality, a season, a time of day, a timestamp, and/or any other suitable parameter value. Each measurement can be: retrieved from a database, retrieved from a real estate listing service (e.g., a multiple listing service, Redfin™, etc.), received from an image provider (e.g., a satellite image provider, drone image provider, etc.), and/or otherwise determined. However, the set of measurements can be otherwise determined.

S200 can optionally include determining parcel data for the property. Parcel data can include: a parcel boundary, a property boundary (e.g., a land boundary), a geofence, a region, a mask, a parcel shape, a parcel position, and/or any other suitable information. The parcel data preferably defines a boundary of a parcel (example shown in FIG. 6), but can additionally and/or alternatively define other parcel parameters. The parcel data can be georeferenced (e.g., aligned with an external geographic coordinate system), referenced to a measurement (e.g., referenced to image coordinates), and/or otherwise referenced. The parcel data can be retrieved from a third-party entity, retrieved from a database 120, inferred using a model, and/or otherwise determined. In examples, the parcel data can be determined using methods as discussed in U.S. application Ser. No. 17/546,620 filed 9 Dec. 2021 and/or U.S. application Ser. No. 17/529,836 filed 18 Nov. 2021, each of which is incorporated in its entirety by this reference. The parcel data can be used: to determine a segmented measurement for the property (e.g., a measurement segment isolated to the property), as additional information provided to the property attribute model (e.g., in a side channel; as additional information to focus the model; etc.), to identify which detected feature instances correspond to a property (e.g., the primary structures, pools, vegetation, etc. associated with an address), to geocode or determine a geographic identifier corresponding to a location description (e.g., an address) of the property (e.g., as discussed in U.S. application Ser. No. 17/546,620 filed 9 Dec. 2021, and/or otherwise used. However, the parcel data can be otherwise determined.

In a first variant, S200 can include retrieving a wide-scale measurement depicting the property of interest (e.g., encompassing the geolocation associated with the property and optionally other properties (e.g., neighboring properties, auxiliary properties, etc.).

In a second variant, S200 can include retrieving a cropped measurement depicting only the property of interest. The cropped measurement can be generated by cropping a wide-scale measurement using the parcel data associated with the property (e.g., the parcel boundary associated with the property identifier), or be otherwise determined.

In a third variant, S200 can include retrieving a wide-scale measurement depicting the property of interest and identifying the measurement segment corresponding to the property (e.g., measurement segment intersecting the parcel; measurement segment within the property geofence; etc.).

However, the information for the property can be otherwise determined.

### 5.3. Determining Property Attributes for the Property S300.

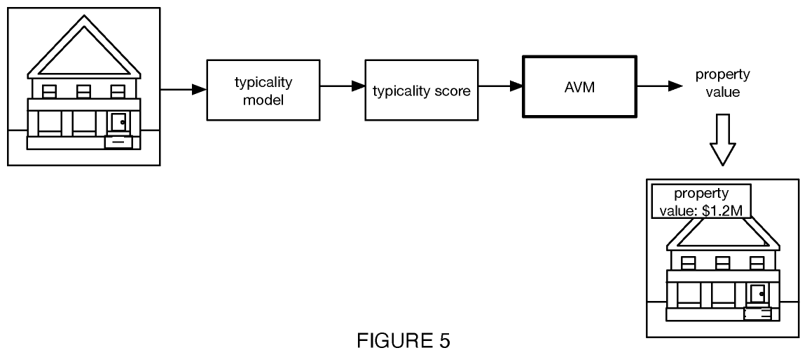

Determining property attributes for the property S300 functions to extract attributes of the property based on a measurement. S300 can be performed after S200, concurrently with S200, before S400, and/or at any other suitable time. Attributes of the property can be one property attribute, multiple property attributes, and/or any other suitable number of property attributes. The attributes (e.g., as described above) can include one or more of: roof condition, building external condition, driveway condition, lawn condition, pool condition, yard debris, roof occlusion, tree overhang, vegetation coverage and/or proximity, overall property condition (e.g., exterior condition), damage detection, quality grade, viewshed and/or viewshed desirability, curb appeal, typicality (e.g., of property relative to neighbors; example shown in FIG. 5), structural density, liquidity (e.g., how easily a property can be sold without reducing price, market state (e.g., bull market, bear market, etc.), house price index (HPI), presence or absence of a built structure, physical or geometric attributes of the built structure, relationships between built structures, living area, square footage, number of stories, property features, and/or any other suitable attributes (described above). Property attribute values can be determined based on: property measurements, property features, other property information (described above) and/or any other suitable data. Property features can be determined from property measurements (e.g., using a property feature model), retrieved from a database, determined manually, and/or otherwise determined. Examples of property features (e.g., objects) that can be detected include: roofs, garages, driveways, sidewalks, pools, decks, sheds, paved surfaces, furniture, vegetation, trees, and/or any other suitable physical features. Property attributes are preferably determined automatically (e.g., using a property attribute model), but can additionally and/or alternatively be determined manually (e.g., by a real estate appraiser) or otherwise determined.

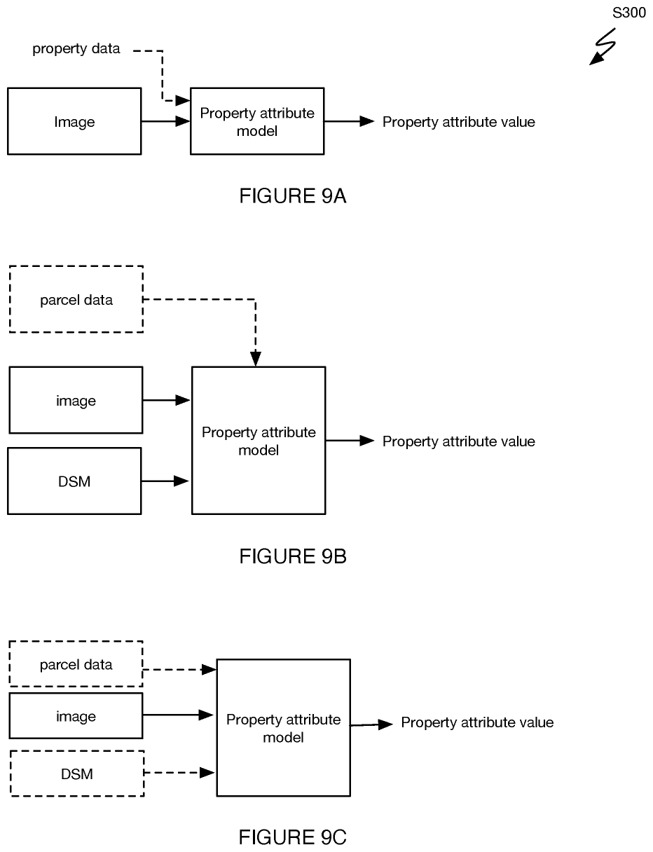

In a first variant, an image can be ingested by a property attribute model to predict property attribute values for one or more property attributes (example shown in FIG. 9A). The image is preferably a property-specific measurement (e.g., a cropped measurement), but can alternatively not be a property-specific measurement.

In a second variant, an image and a DSM can be ingested by a property attribute model to predict property attribute values for one or more property attributes (example shown in FIG. 9B. The image and the DSM are preferably property-specific measurements, but can alternatively not be property-specific measurements.

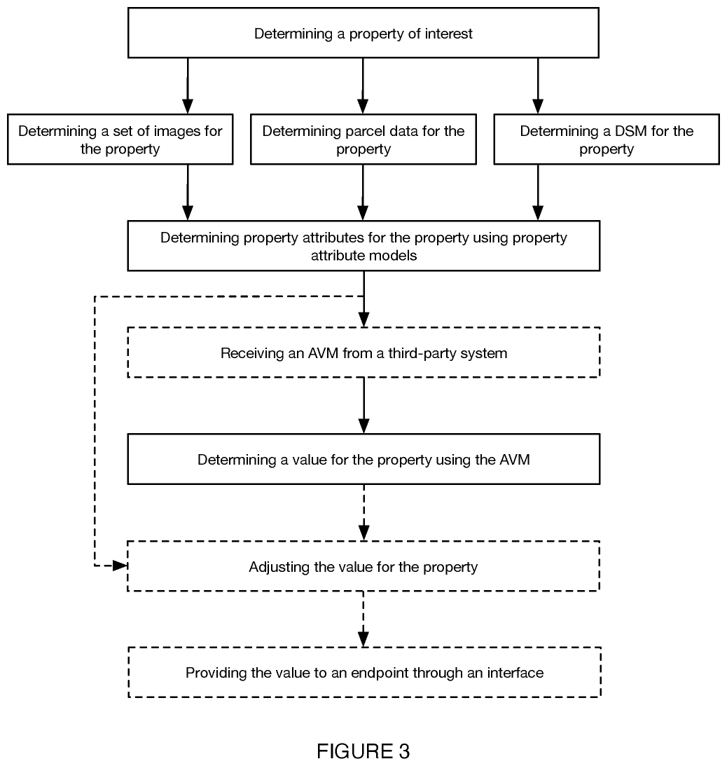

In a third variant, an image, a DSM, and parcel data/geofence can be ingested by a property attribute model to predict a property attribute value for one or more property attributes; example shown in FIG. 3. The image, DSM, and parcel data/geofence can be wide-scale (e.g., depict multiple properties) or not be wide-scale. The parcel data can be used to focus the property attribute model on property-related pixels (e.g., by the property attribute model's attention layer; example shown in FIG. 9B and FIG. 9C).

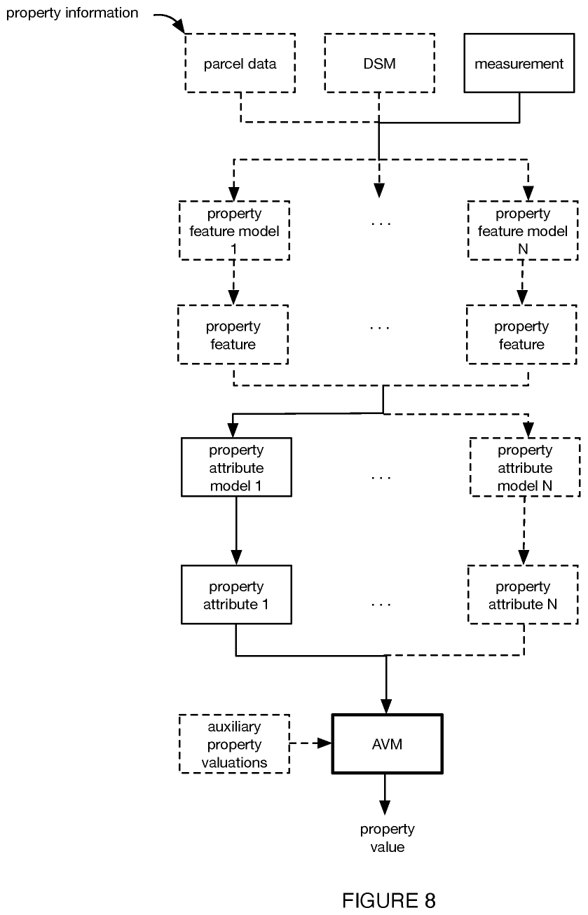

In a fourth variant, an image and optionally parcel data can be ingested by a property feature model to extract property feature instances for one or more properties (example shown in FIG. 8). The property feature instances associated with the property of interest can be identified using parcel data, and the property feature instances can be used as inputs into a property attribute model to predict a property attribute value for one or more property attributes. Identifying property feature instances associated with the property of interest using parcel data can include: using parcel data to extract only the property attribute for the property of interest and determining property feature instances overlapping, intersecting, and/or located within the parcel area (example shown in FIG. 6B); segmenting the measurement using the parcel data and detecting the features from within the measurement segment (example shown in FIG. 6A); and/or otherwise determined.

In a fifth variant, S300 can include retrieving predetermined property features and/or property attributes associated with geographic locations within the parcel and/or associated with a property geocode.

In a sixth variant, S300 can include receiving property features and/or property attributes from a third-party system (e.g., real estate listing service).

However, the property attributes for the property can be otherwise determined.

5.4. Determining a Value for the Property S400.

Determining a value for the property S400 functions to predict a market value for the property of interest (e.g., market price). S400 can be performed before after S200, concurrently with S300, after S300, before S500, and/or at any other suitable time. S400 can be performed: periodically, when requested, at random times, as a batch (e.g., for one or more properties), when new data is received, and/or otherwise at any other time. The value is preferably numerical (e.g., a number in any currency, an uncertainty measure, etc.), but can additionally and/or alternatively be categorical (e.g., a ranking, a classification, etc.).

The value is preferably determined using an AVM, but can additionally and/or alternatively be determined using a different model, determined manually (e.g., by a real estate appraiser), and/or otherwise determined. S400 can include inputting property attributes for the property (e.g., determined in S300) into the AVM, wherein the AVM can predict the value for the property. The AVM can be specific to one or more properties, property types (e.g., single-family home, multi-family home, commercial, residential, etc.), geographic regions (e.g., specific to a particular county or tax assessment region), specific to one or more attributes (e.g., attribute types, attribute value ranges, etc.), specific to one or more measurement parameters, generic to any of the above, and/or other specific or generic. The AVM can be retrieved from a database 120, trained and/or fine-tuned, received from a third-party system, and/or otherwise determined.

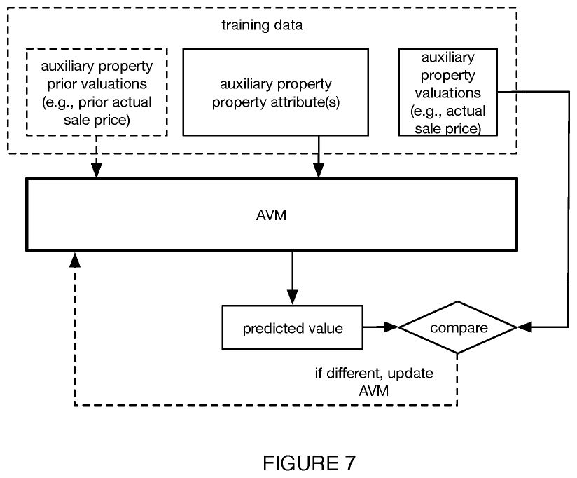

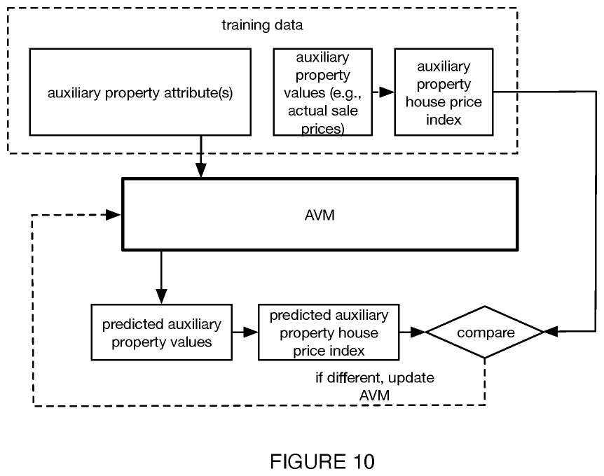

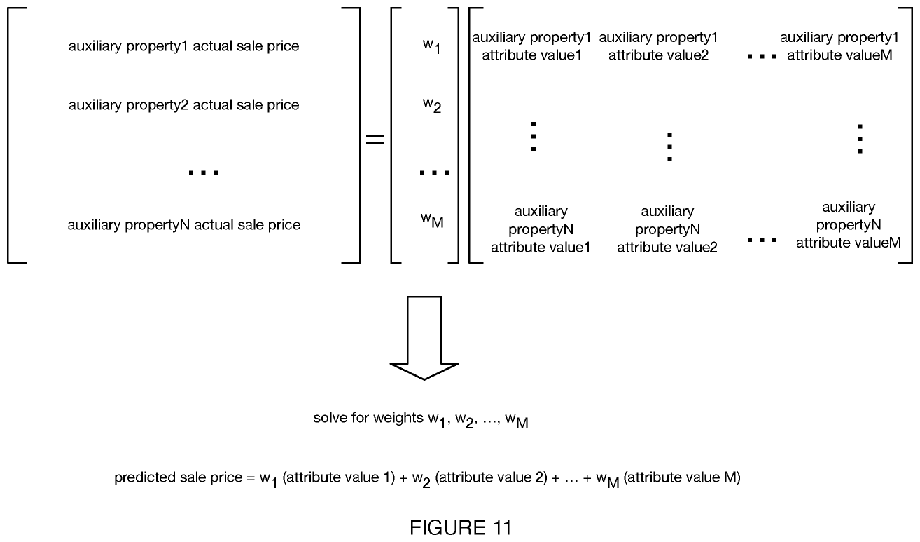

The AVM can be trained based on: one or more auxiliary properties (e.g., auxiliary property valuations), one or more other properties (e.g., non-auxiliary properties), and/or any other suitable training properties. Auxiliary properties preferably share structural attribute values with the property of interest (e.g., similar number of beds/baths, square footage, neighborhood, etc.), but can additionally and/or alternatively share market attribute values (e.g., sold within the last N days), share other property attribute values, not share any property attribute values, and/or share any other suitable set of property attribute values with the property of interest. Properties within the training property set can be previously transacted, previously transacted within a predetermined timeframe, not previously transacted, and/or otherwise transacted. The duration of the timeframe can be: predetermined, selected based on market conditions, determined based on a current time (e.g., a predetermined duration prior to the current duration), randomly selected, and/or otherwise selected. The training target for the AVM can be: binary, non-binary, numerical, categorical, discrete, continuous, and/or any other suitable characteristic. The training target can be: determined from sale transactions (e.g., auxiliary property sale prices), manually determined (e.g., by an appraiser), determined by a third-party (e.g., real estate listing service, real estate marketplace, etc.), determined by an agency (e.g., Federal Housing Finance Agency), by a different model and/or algorithm, a combination thereof, and/or otherwise determined. Examples of training targets can include: past sale prices, house pricing indexes, attribute values, and/or any other suitable training target. Training data for a training property can be associated with a time window or not be associated with a time window. The time window can be static or dynamic. In a first example, training data for a training property is determined for all-time. In a second example, training data for a training property is selected from a dynamic time window (e.g., a sliding time window) that starts from a specific date (e.g., today's date, another reference date, etc.). However, the training data can be determined from any other suitable time window. Training data can include: measurements, attribute values (e.g., extracted from a measurement), property values, and/or any other suitable property information. For example, the training data for a training property can include attribute values that are extracted from a measurement that was sampled contemporaneously (e.g., in the same time frame) with the property value determined. However, the training data can include any other suitable information. The AVM can be trained using auxiliary properties as training properties for the property of interest or be trained using non-auxiliary properties as training properties for the property of interest. In a first example, the AVM is trained to predict the actual sale prices for the training properties based on the training properties' attributes (example shown in FIG. 7). In a second example, the training target is a trend value (e.g., house price index) determined based on the actual sale prices for the training properties. The AVM is trained to predict valuations for the training properties based on the training properties' attributes, wherein the valuations are used to calculate a predicted trend value (e.g., house price index) (example shown in FIG. 10). The predicted trend value is then compared against the actual trend value (e.g., determined based on the actual sale), and the model is updated based on the comparison. Alternatively, the AVM can be trained to predict the house price index directly. In a third example, the AVM is a regression model trained to predict the actual sale price for a property based on actual sale prices of the property's auxiliary properties and attribute values of the property's auxiliary properties (example shown in FIG. 10). However, the AVM can be otherwise trained.

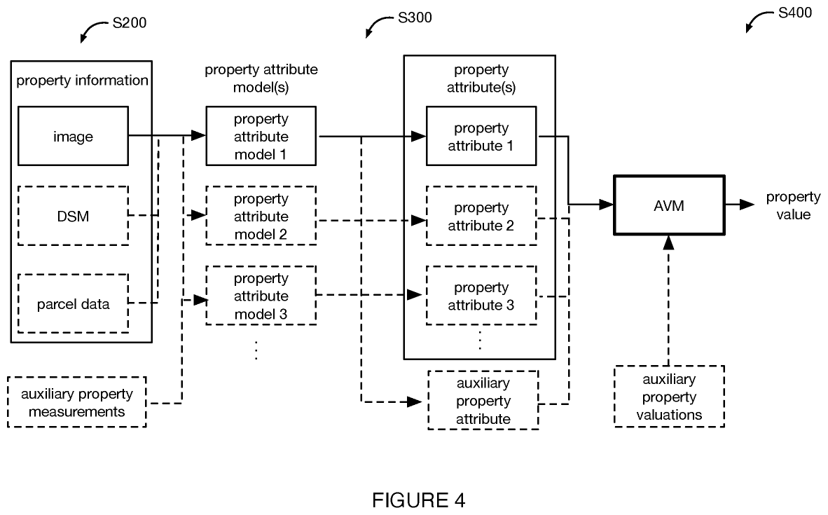

In a first variant, S400 can include using property attribute values, and optionally auxiliary property valuation and auxiliary property attribute values as inputs to an AVM that outputs a predicted property of interest valuation; example shown in FIG. 4.

In a second variant, S400 can include using auxiliary property valuations as inputs to an AVM that outputs a predicted property of interest valuation. The property of interest attribute values and optionally auxiliary property attribute values can be used as inputs to an error model that outputs an error value for the predicted property of interest valuation. In variants, the error model can be used to adjust the valuation predicted by a third-party AVM. In a first embodiment, the error model estimates the valuation error based on only the property attribute values. In a second embodiment, the error model estimates the valuation error based on the property attribute values and the auxiliary property attribute values (e.g., the difference in values). In a third embodiment, the error model estimates valuation error based on property attribute values and auxiliary property values, and optionally auxiliary property attribute values. However, the valuation error can be determined based on any other information. In an example, the error model is a neural network trained to predict an error (e.g., based on training attribute values and actual error between the predicted valuation and the actual valuation). However, the error model can be otherwise configured.

In a third variant, S400 can be performed for multiple properties of interest. S400 can include predicting a valuation for each property of interest using the respective auxiliary property valuation, and then using the property attribute values of the multiple properties to rank the properties (e.g., post evaluation). The ranked properties can be used to determine: which property among the ranked properties has (or should have) the highest valuation, which property among the ranked properties has (or should have) the lowest valuation, and/or otherwise used.

In a fourth variant, S400 can include using property attribute values as inputs to an AVM that outputs a predicted property of interest valuation (e.g., with or without auxiliary property valuations). In this variant, the AVM can be trained to predict property valuation given attribute values for each of a set of training properties and the respective training property's valuation.

However, the value for the property can be otherwise determined.

S400 can optionally include providing the value to an endpoint through an interface. The endpoint can be: an endpoint on a network, a customer endpoint, a user endpoint, a partner endpoint, an AVM system, a real estate listing service, an insurance system, and/or any other suitable endpoint. The interface can be: a mobile application, a web application, a desktop application, an API, a database, and/or any other suitable interface executing on a user device, gateway, and/or any other computing system. However, the value for the property can be otherwise provided.

### 5.5. Adjusting the Value for the Property S500.

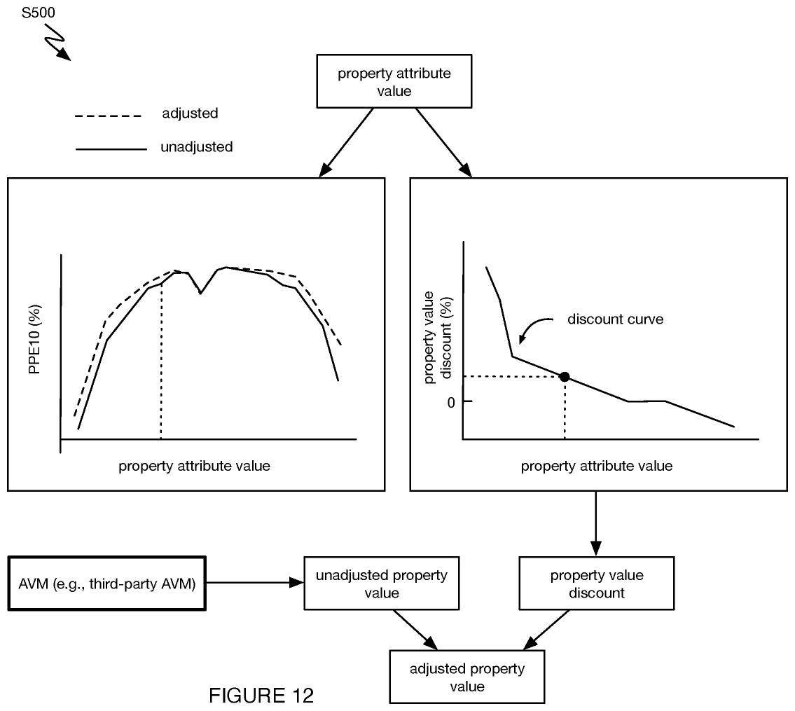

The method can optionally include adjusting the value for the property S500 functions to adjust the predicted property value to obtain a more accurate value. S500 can be performed before S400, concurrently with S400, and/or at any other suitable time. In use, the (unadjusted) property value (to be adjusted) is preferably determined by a third-party system (e.g., predicted by a third-party AVM), but can additionally and/or alternatively be determined by the system 10 and/or any other suitable system. The property value is preferably adjusted based on one or more attribute values (e.g., condition attribute values; example shown in FIG. 12), but can additionally and/or alternatively be adjusted based on property information, auxiliary property valuations, and/or any other suitable data. The adjustment to the property value is preferably a downward adjustment, but can alternatively be an upward adjustment, and/or any other suitable adjustment. The adjustment is preferably dynamic, but can additionally and/or alternatively be static, and/or have any other suitable characteristic. The property value is preferably adjusted automatically using an adjustment model (e.g., discount curve), but can additionally and/or alternatively be manually adjusted, and/or otherwise adjusted. The adjustment model is preferably specific to an AVM, but can additionally and/or alternatively be specific to one or more attributes, specific to a third-party, specific to a set of properties, specific to a data provider/vendor, generic among AVMs, generic among third-parties, generic among properties, generic among data providers/vendors, and/or otherwise be specific or generic. The adjustment model is preferably determined based on a performance metric (e.g., AVM error, a percentage of time the AVM is within 10% of the benchmark, a percentage of properties whose predicted value is within 10% of the actual value (PPE10), etc.) of the AVM, but can additionally and/or alternatively be determined based on a market position adjustment, and/or otherwise determined. For example, the adjustment model is a discount curve (example shown in FIG. 12) generated by: for each property attribute value within a range of values (e.g., continuous range, discrete range, etc.) for a particular property attribute, determining a set of training properties; calculating a performance value (e.g., PPE10 value) for the set of training properties; correlating the performance value against the property attribute value for each training property; determining an adjustment factor (property value discount percentage) such that the performance value is substantially normalized across the entire range for the property attribute (e.g., such that PPE10 is as flat as possible for all property attribute values of the property attribute); and creating a discount curve wherein the property attribute value is associated with the respective adjustment factor (e.g., the property value adjustment needed to flatten the PPE10 curve) on the discount curve. In an illustrative example, this can include tabulating the PPE10 for a training property against the liquidity score for the training property, which can result in an inverted U-curve when plotted out, with low PPE10 for high and low property liquidity scores, wherein the adjustment for each liquidity score is determined such that the resultant PPE10-liquidity score plot (using for the adjusted values) is substantially flat. In another illustrative example, this can include plotting the property distance to a busy road against the performance value, which can result in a monotonically increasing line in the distance range of interest, wherein the adjustment for each distance is determined such that the adjusted performance value-distance curve is substantially flat. The adjustment factor can be an absolute value (e.g., a numerical value), a percentage (e.g., a discount percentage), a decimal, and/or any other suitable adjustment factor. The attribute used as the reference for the adjustment can be: randomly selected, manually specified, be a hybrid attribute (e.g., formed from multiple attributes), an attribute selected to maximize the deviation (e.g., maximize the range) in the unadjusted performance score-attribute plot, and/or otherwise selected. In another example, the adjustment model is a discount curve generated by: determining a market position adjustment (e.g., valuation adjustment, HPI adjustment, etc.) based on a comparison between (e.g., difference between the AVM-predicted market position values and the actual market position values (e.g., determined post-sale) for each of a set of test properties, determining the property attribute values for each of the set of test properties, and correlating the property attribute value with the respective market position adjustment for the test property.

In a first variant, S500 can include determining a property value discount using a discount curve based on a property attribute value and adjusting the raw property value outputted by a third-party AVM based on the property value discount. In an illustrative example, S500 can include: receiving a raw property value for a property of interest from a third-party AVM system; determining a condition attribute value for the property of interest using the condition attribute value model; retrieving a discount curve (adjustment model) specific to the third-party AVM system; determining a property value discount associated with the condition attribute value on the discount curve; and determining the adjusted property value based on the raw property value and the property value discount (e.g., reducing the raw property value by the property discount percentage); example shown in FIG. 12. In an illustrative example, a subject property is estimated to be $1 M by the AVM, and the subject property has a liquidity score of 20. If, according to the discount curve, a liquidity score of 20 is associated with a 12% discount that is to be applied to the AVM output, then the $1 M valuation would be reduced by 12%, so that the final price is $880 K.

In a second variant, S500 can include determining an adjusted property value using a machine learning model (e.g., adjustment model; error model; correction model; secondary model; etc.) that ingests the unadjusted property value outputted by the AVM and property attribute values (e.g., house price index, market attributes, structural attributes, condition attributes, etc.) and outputs the adjusted property value.

In a third variant, an appraiser manually adjusts the property value based on inspection.

However, the value for the property can be otherwise adjusted.

S500 can optionally include providing the adjusted value to an endpoint through an interface. The endpoint can be: an endpoint on a network, a customer endpoint, a user endpoint, a partner endpoint, an AVM system, a real estate listing service, an insurance system, and/or any other suitable endpoint. The interface can be: a mobile application, a web application, a desktop application, an API, a database, and/or any other suitable interface executing on a user device, gateway, and/or any other computing system. However, the adjusted value for the property can be otherwise provided.

### 6. Use Cases

The estimated property valuation can be used in various applications. The value can be used to target on-market investment opportunities (e.g., for real estate investors, real estate brokers, mortgage originators, etc.) and/or off-market investment opportunities (e.g., for loan traders, refinance and HELOC originators, iBuyers, etc.). Examples of on-market investment opportunities include: automatically identifying real-time real estate listings to bid on best deals when they hit the market based on the predicted property values, leveraging accurate property condition-sensitive values to avoid bidding too high based on the predicted property values, and/or screening properties so low bids are justified to maintain credibility with local real estate agents based on the predicted property values. Examples of off-market investment opportunities include: identifying properties that are discounted below market value due to condition issues based on the predicted property values, identifying properties less expensive than top of a buy box that were seemingly out of reach based on the predicted property values, screening properties that have a propensity of sell at a discount based on the predicted property values. In other examples, the value can be used to generate reports (e.g., analyses), identify potential areas of repairs/renovation by being aware of what aspects of the property significantly contribute to the value while getting the property ready for listing, to supplement a property-level valuation report, and to detect error in other valuation methods.

However, the value can be otherwise used.

The method can optionally include determining interpretability and/or explainability of the trained model, wherein the identified attributes (and/or values thereof) can be provided to a user, used to identify errors in the data, used to identify ways of improving the model, and/or otherwise used. Interpretability and/or explainability methods can include: local interpretable model-agnostic explanations (LIME), Shapley Additive explanations (SHAP), Ancors, DeepLift, Layer-Wise Relevance Propagation, contrastive explanations method (CEM), counterfactual explanation, Protodash, Permutation importance (PIMP), L2X, partial dependence plots (PDPs), individual conditional expectation (ICE) plots, accumulated local effect (ALE) plots, Local Interpretable Visual Explanations (LIVE), breakDown, ProfWeight, Supersparse Linear Integer Models (SLIM), generalized additive models with pairwise interactions (GA2Ms), Boolean Rule Column Generation, Generalized Linear Rule Models, Teaching Explanations for Decisions (TED), and/or any other suitable method and/or approach.

All or a portion of the models discussed above can be debiased (e.g., to protect disadvantaged demographic segments against social bias, to ensure fair allocation of resources, etc.), such as by adjusting the training data, adjusting the model itself, adjusting the training methods, and/or otherwise debiased. Methods used to debias the training data and/or model can include: disparate impact testing, data pre-processing techniques (e.g., suppression, massaging the dataset, apply different weights to instances of the dataset), adversarial debiasing, Reject Option based Classification (ROC), Discrimination-Aware Ensemble (DAE), temporal modelling, continuous measurement, converging to an optimal fair allocation, feedback loops, strategic manipulation, regulating conditional probability distribution of disadvantaged sensitive attribute values, decreasing the probability of the favored sensitive attribute values, training a different model for every sensitive attribute value, and/or any other suitable method and/or approach.

Different subsystems and/or modules discussed above can be operated and controlled by the same or different entities. In the latter variants, different subsystems can communicate via: APIs (e.g., using API requests and responses, API keys, etc.), requests, and/or other communication channels.

Different processes and/or elements discussed above can be performed and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various elements discussed above, and/or omit one or more of the discussed elements, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A method, comprising:
determining a set of measurements depicting a property of interest;
determining parcel data associated with the property of interest;
determining a set of property condition attributes using a set of attribute models based on the set of measurements and the parcel data; and
generating a predicted property value for the property of interest using an automated valuation model, given the set of property condition attributes.

2. The method of claim 1, wherein the set of property condition attributes comprises at least one of a roof condition, a pool condition, a lawn condition, or a driveway condition.

3. The method of claim 1, further comprising training the automated valuation model based on a set of auxiliary properties, wherein each auxiliary property of the set of auxiliary properties is associated with a set of auxiliary property attribute values and an actual auxiliary property value.

4. The method of claim 3, wherein training the automated valuation model comprises:
for each auxiliary property of the set of auxiliary properties:
generating a predicted auxiliary property value using the automated valuation model, given the respective set of auxiliary property attribute values of each auxiliary property; and
training the automated valuation model based on a comparison between the actual auxiliary property value of the auxiliary property and the respective predicted auxiliary property value.

5. The method of claim 3, wherein training the automated valuation model comprises:
determining an actual trend based on the actual auxiliary property value of each auxiliary property;
for each auxiliary property of the set of auxiliary properties:
generating a predicted auxiliary property value using the automated valuation model, given the respective set of auxiliary property attribute values of each auxiliary property;
determining a predicted trend based on the predicted auxiliary property value of each auxiliary property; and
training the automated valuation model based on a comparison between the actual trend value and the predicted trend value.

6. The method of claim 5, wherein the actual and predicted trend values each comprise a house price index.

7. The method of claim 1, wherein an attribute model of the set of attribute models ingests the parcel data and the set of measurements and outputs a property condition attribute of the set of property condition attributes.

8. The method of claim 1, further comprising extracting a set of property features from the set of measurements using a set of property feature detectors, wherein the set of property condition attributes is further determined based on the set of property features.

9. The method of claim 1, wherein the set of measurements comprises a 3D measurement.

10. The method of claim 1, wherein the automated valuation model comprises an unsupervised foundation model.

11. A system, comprising:
a processing system, configured to:
determine a set of measurements depicting a property of interest;
determine parcel data associated with the property of interest;
determine a set of property condition attributes using a set of attribute models based on the set of measurements and the parcel data;
determine an adjustment factor based on the set of property condition attributes; and
provide the set of property condition attributes and the adjustment factor to a third-party system, wherein the third-party system determines a final property value for the property of interest using an automated valuation model, given the set of property condition attributes and the adjustment factor.

12. The system of claim 11, wherein the set of measurements comprises aerial imagery.

13. The system of claim 11, wherein the automated valuation model ingests the set of property condition attributes and outputs a predicted property value, wherein the final property value is determined using the predicted property value and the adjustment factor.

14. The system of claim 11, wherein determining the adjustment factor based on the set of property condition attributes comprises:
determining a discount curve associated with a property condition attribute of the set of property condition attributes; and
determining a property discount value using the discount curve based on a property condition attribute value for the property condition attribute, wherein the adjustment factor comprises the property discount value.

15. The system of claim 11, wherein the processing system is further configured to extract a set of property features from the set of measurements using a set of property feature detectors, wherein the set of property condition attributes is further determined based on the set of property features.

16. The system of claim 14, wherein the discount curve is specific to the automated valuation model.

17. The system of claim 14, wherein the discount curve is determined by:
for each property attribute value within a range for the property condition attribute:
determining a set of training properties;
determining a set of actual property values for the set of training properties;
determining a performance value for the automated valuation model wherein the automated valuation model outputs a first set of predicted property values for the set of training properties, wherein the performance value is determined based on a comparison between the first set of predicted property values and the set of actual property values; and
determining an adjustment factor such that the performance value is normalized across the range of property attribute values for the property condition attribute.

18. The system of claim 17, wherein the performance value comprises a percentage of properties with predicted property values that are within 10% of actual property values (PPE10).

19. The system of claim 11, wherein the parcel data comprises a parcel boundary for the property of interest, wherein determining the set of property condition attributes comprises:
segmenting a measurement of the set of measurements using the parcel boundary; and
extracting a property condition attribute of the set of property condition attributes from the segmented measurement using an attribute model of the set of attribute models.

20. The system of claim 11, wherein an attribute model of the set of attribute models ingests the parcel data and the set of measurements and outputs a property condition attribute of the set of property condition attributes.
